(19) United States
(12) Patent Application Publication
(10) Pub. No.: US 2010/0013423 A1
(43) Pub. Date: Jan. 21, 2010

(54) CONTROL CIRCUITRY OF CEILING FAN FOR CONTROLLING ROTATION DIRECTION AND SPEED

(75) Inventor: Chien-Hsun CHEN, Taichung (TW)

Correspondence Address: BROWDY AND NEIMARK, P.L.L.C.;624 NINTH STREET, NW, SUITE 300, WASHINGTON, DC, 20001-5303, US

(73) Assignee: RHINE ELECTRONIC CO., LTD, Tan-Zi Shiang (TW)

(21) Appl. No.: 12/186,859

(22) Filed: Aug. 6, 2008

(30) Foreign Application Priority Data
Jul. 15, 2008 (TW) 97126845

(51) Int. Cl. H02P 7/18

(52) U.S. Cl. 318/400.42

(57) ABSTRACT

A control circuitry of a ceiling fan for controlling speed and direction of rotation of the ceiling fan includes a power switch, an electromagnetic interference reduction circuit connected to the power switch, a power frequency detecting circuit connected to the electromagnetic interference reduction circuit, a central processor connected to the power frequency detecting circuit, a motor driving circuit connected to the central processor and a brushless motor, a rectification and filter circuit connected to the electromagnetic interference reduction circuit and the motor driving circuit, and a power supply circuit connected to the power frequency detecting circuit and the central processor. When the power switch is operated, it will generate interruptions, and the central processor will sense these interruptions and determine which are commands for speed change and which are commands for direction change according to the time of the interruptions to control the brushless motor through the motor driving circuit.

### BACKGROUND OF THE INVENTION

1. Field of the Invention

The present invention relates to a ceiling fan and more particularly, to a control circuitry of a ceiling fan for controlling rotation direction and speed thereof.

2. Description of the Related Art

FIG. 1 shows a conventional circuitry 10 of a ceiling fan for manually controlling the rotation direction and speed. The circuitry 10 includes a rotary switch 11 to control the speed, and a switch 12 to control the direction. Such circuitry 10 of the ceiling fan is troublesome for operation. In practice, the rotary switch 11 and the switch 12 are connected to a controller that the switch 12 usually is directly provided on a case, in which a motor is received, and the rotary switch 11 is provided in the case with a string left out of the case for manipulation. This structure is very incontinent to user because that the ceiling fan is hung on a ceiling so that a normal person is hard to reach the switch 11. As a result, the switch 11 is never operated. Besides, the ceiling fan is provided with a tube for hanging it. In the tube, there already are three power lines and three to five control signal lines. It is too crowded for lines of the rotary switch 11 and the switch 12 through the tube. It makes more difficult to mount the ceiling fan and raises the cost also.

### SUMMARY OF THE INVENTION

The primary objective of the present invention is to provide a control circuitry of a ceiling fan, which may control a rotation direction and speed of the ceiling fan with fewer assembling and repairing problems.

To achieve the objective of the present invention, a control circuitry of a ceiling fan for controlling speed and direction of rotation of the ceiling fan includes a power switch connected to an AC power, an electromagnetic interference reduction circuit connected to the power switch, a power frequency detecting circuit connected to the electromagnetic interference reduction circuit to transfer a sin wave signal to a square wave, a central processor connected to the power frequency detecting circuit to receive the square waves from the power frequency detecting circuit, a motor driving circuit connected to the central processor and a brushless motor, a rectification and filter circuit connected to the electromagnetic interference reduction circuit and the motor driving circuit, and a power supply circuit connected to the power frequency detecting circuit and the central processor to supply the central processor power. When the power switch is operated, it will generate an interruption between the square waves, and the central processor will sense these interruptions and determine which are commands for speed change and which are commands for direction change according to how long of the interruptions to control the brushless motor through the motor driving circuit.

### BRIEF DESCRIPTION OF THE DRAWINGS

FIG. 1 is a circuit diagram of the conventional control circuitry of a ceiling fan;

FIG. 2 is a block diagram of a first preferred embodiment of the present invention;

FIG. 3 is a circuit diagram of a power frequency detecting circuit of the preferred embodiment of the present invention; and

FIG. 4 is a block diagram of a second preferred embodiment of the present invention.

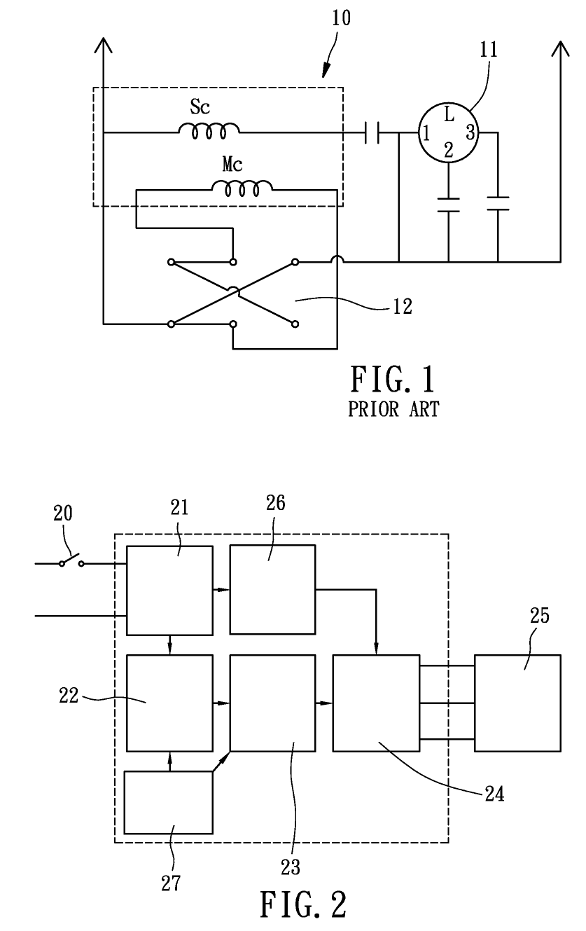

### DETAILED DESCRIPTION OF THE INVENTION

FIGS. 2 shows a control circuitry of a ceiling fan of the first preferred embodiment of the present invention, which includes:

A power switch 20 is connected to an AC power (not shown).

An electromagnetic interference (EMI) reduction circuit 21 is connected to the power switch 20.

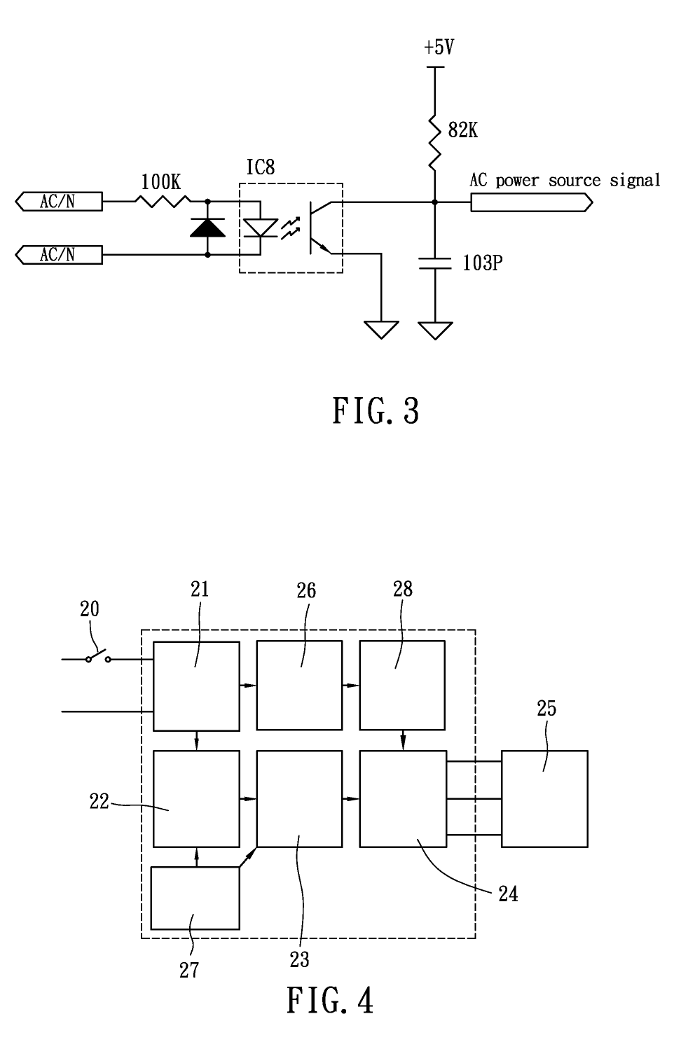

A power frequency detecting circuit 22 is connected to the EMI reduction circuit 21 to transfer a sin wave signal to a square wave. For example, the function of the power frequency detecting circuit 22 is set by a central processor to transfer a sin wave of AC120V, 60 Hz to a square wave of 50 Hz or 60 Hz. The power frequency detecting circuit 22 may select optoelectronic devices to get power frequency signals by isolation. FIG. 3 shows a circuit diagram of a power frequency detecting circuit, which may prevent the damage of high potential attacking the system.

A central processor 23 is connected to the power frequency detecting circuit 22 to receive the square waves of the power frequency detecting circuit 22. The central processor 23 is provided with a control program to detect interrupted times between the square waves and provide control signals according the interrupted times.

A motor driving circuit 24 is connected to the central processor 23 and a brushless motor 25 to control the brushless motor 25 according to the control signals of the central processor 23.

A rectification and filter circuit 26 is connected to the EMI reduction circuit 21 and the motor driving circuit 24.

A power supply circuit 27 is connected to the power frequency detecting circuit 22 and the central processor 23 to supply the central processor 23 power.

In a normal operation of the control circuitry of the present invention, the central processor 23 receives the square waves from the power frequency detecting circuit 22. When the power switch 20 is operated, it will generate interruptions in the square waves, and the central processor 23 will sense them. The control program of the central processor 23 will determine which one is a command for speed change and which one is a command for direction change according to the time of the interruptions, and generate a control signal according to the very command. In the present invention, the central processor 23 determines a command for speed change when the interruption time is less than one second that the central processor 23 will control the brushless motor 25 to speed up or to slow down through the motor driving circuit 24. On the contrary, the central processor 23 will determine a command for direction change when the interruption time is greater than three seconds that the central processor 23 will cut the power of the brushless motor 25 through the motor driving circuit 24 first, and then send a reverse rotation command to the motor driving circuit 24 to drive the brushless motor 25 rotating reversely.

In the control of speed, the present invention provides a circulating control. For example, suppose that the ceiling fan has three levels of speeds, and the speed change will circulate from the first level, the second level, the third level to OFF in sequence and circulation. To keep the central processor 23 in function when the power is interrupted, the power supply circuit 27 is provided with a capacity (not shown) to supply the central processor 23 power. But when the interruption time is too long that the capacity has not enough power, the central processor 23 will determine the power is off, and will reboot when the power is connected.

In conclusion, the control circuitry of the present invention only provides the power switch to be operated for controlling three functions, including speed control, direction control, and power ON/OFF, of the ceiling fan rather than two switches to control the functions as the conventional control circuitry does. The present invention has fewer problems in assembling and has a lower cost also.

FIG. 4 shows a control circuitry of the second preferred embodiment of the present invention, which is basically as same as the first preferred embodiment, except that it further includes a power factor correction (PFC) circuit 28 connected to the rectification and filter circuit 26 and the motor driving circuit 24 to increase the power factor.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A control circuitry of a ceiling fan for controlling speed and direction of rotation of the ceiling fan, comprising:
a power switch connected to an AC power;
an electromagnetic interference reduction circuit connected to said power switch;
a power frequency detecting circuit connected to said electromagnetic interference reduction circuit to transfer a sin wave signal to a square wave;
a central processor connected to said power frequency detecting circuit to receive said square waves from said power frequency detecting circuit, wherein said central processor has a control program to sense interruptions in said square waves when said power switch is operated and determine which are commands for speed change and which are commands for direction change according to time of said interruption;
a motor driving circuit connected to said central processor and a brushless motor to control said brushless motor according to said commands of said central processor;
a rectification and filter circuit connected to said electromagnetic interference reduction circuit and said motor driving circuit; and
a power supply circuit connected to said power frequency detecting circuit and said central processor to supply said central processor power.

2. The control circuitry as claimed in claim 1, wherein said central processor determines it is a command for direction change when a long interruption is sensed, and said central processor determines it is a command for speed change when a short interruption is sensed.

3. The control circuitry as claimed in claim 1, wherein said power supply circuit is provided with a circuit to supply power to said central processor.

4. The control circuitry as claimed in claim 1, further comprising power factor correction circuit connected to said rectification and filter circuit and said motor driving circuit.
